(19) United States
(12) Patent Application Publication
(10) Pub. No.: US 2016/0372032 A1
(43) Pub. Date: Dec. 22, 2016

(54) ORGANIC LIGHT EMITTING DISPLAY DEVICE AND DRIVING METHOD THEREOF

(71) Applicant: Samsung Display Co., Ltd., Yongin-si (KR)

(72) Inventors: Jin Wook YANG, Yongin-si (KR); Young Wook YOO, Yongin-si (KR)

(21) Appl. No.: 15/002,332

(22) Filed: Jan. 20, 2016

(30) Foreign Application Priority Data
Jun. 16, 2015 (KR) 10-2015-0085444

(51) Int. Cl. G09G 3/3225; G09G 3/3283; G09G 3/20

(52) U.S. Cl. CPC G09G 3/3225; G09G 3/2007; G09G 3/3283; G09G 2320/043; G09G 2310/08; G09G 2300/0842; G09G 2320/0673

(57) ABSTRACT

An organic light emitting display device includes: a compensator configured to extract current information of organic light emitting diodes in pixels; and a timing controller configured to determine a luminance compensation amount corresponding to the current information and to generate second data by adjusting bits of first data supplied from an outside, the first data being adjusted corresponding to the luminance compensation amount, wherein the compensator is further configured to divide a current variation corresponding to deterioration of the organic light emitting diodes into k sections and to calculate the luminance compensation amount using a linear function of a luminance variation corresponding to the current variation at each of the k sections.

### CROSS-REFERENCE TO RELATED APPLICATION

This application claims priority to and the benefit of Korean Patent Application No. 10-2015-0085444, filed on Jun. 16, 2015, in the Korean Intellectual Property Office, the entire content of which is incorporated herein by reference.

### BACKGROUND

1. Field

Exemplary embodiments of the present invention relate to an organic light emitting display device and a driving method thereof.

2. Description of the Related Art

Recently, there have been developed various flat panel display devices reduced in weight and bulk that are capable of eliminating disadvantages of a cathode ray tube (CRT). Examples of these flat panel display devices include a liquid crystal display, a field emission display, plasma display panel, and an organic light emission display device.

Among the flat panel displays, the organic light emitting display device displays images using organic light emitting diodes which generate light by using recombination of electrons and holes, thereby accomplishing quick response speed and low driving power consumption.

The organic light emitting display device includes a plurality of pixels disposed at regions that are divided by a plurality of data lines and scan lines. Typically, the pixels include an organic light emitting diode, two or more transistors including a driving transistor, and one or more capacitors.

The organic light emitting diode included in each of the pixels deteriorates as time goes on, and thus it may be difficult to display image with desired luminance levels. Accordingly, a study on a method for compensating the deterioration of the organic light emitting diode has been conducted.

The above information disclosed in this Background section is only for enhancement of understanding of the background of the invention and therefore it may contain information that does not form prior art.

### SUMMARY

In view of the above, embodiments of the present invention provide an organic light emitting display device and a driving method thereof, which can improve display quality.

In accordance with an embodiment of the present invention, there is provided an organic light emitting display device including: a compensator configured to extract current information of organic light emitting diodes in pixels; and a timing controller configured to determine a luminance compensation amount corresponding to the current information and to generate second data by adjusting bits of first data supplied from an outside, the first data being adjusted corresponding to the luminance compensation amount, wherein the compensator is further configured to divide a current variation corresponding to deterioration of the organic light emitting diodes into k sections and to calculate the luminance compensation amount using a linear function of a luminance variation corresponding to the current variation at each of the k sections.

The linear function may be set as Equation 1:

ΔL=αΔI+β, Equation 1

wherein α and β are constant values of the equation, ΔI is a current variation, and ΔL is a luminance variation in Equation 1.

The constant values α and β of the linear function may be set differently at each of the k sections.

The constant values of the linear function may be identically or differently set for each of the pixels in each of the k sections.

The compensator may include a storage configured to store constant values of first pixels for each of the k sections, the first pixels being some of the pixels, a calculator configured to calculate constant values of second pixels for each of the k sections, the second pixels being pixels other than the first pixels from among the pixels, a current measurer configured to determine the current variation, and a selector configured to select constant values of the first pixels and the second pixels for each of the k sections corresponding to the current variation.

The calculator may extract constant values of two or more of the first pixels that are adjacent to a specific one of the second pixels for each of the k sections, and calculate a constant value of the specific one of the second pixels for each of the k sections using an interpolation.

The current measurer may supply a reference voltage to the organic light emitting diode of each of the pixels, and determine the current variation by comparing a current flowing in the organic light emitting diode with a reference current indicating a current flowing in the organic light emitting diode corresponding to the reference voltage when the organic light emitting diode is not deteriorated.

The timing controller may include a data compensator configured to calculate the luminance compensation amount using Equation 2, and to generate the second data by multiplying the first data by the luminance compensation amount:

ΔT=1/(1−ΔL), Equation 2

wherein ΔT is a luminance compensation amount in Equation 2.

The timing controller may further include a data adjuster configured to reduce bits of the first data by a ratio when bits of at least one of the second data exceed a region that can be expressed with grayscale values.

The data compensator may generate the second data by applying a gamma value on the luminance compensation amount in an analog mode.

In accordance with another embodiment of the present invention, there is provided a driving method of an organic light emitting display device, including: determining a current variation corresponding to deterioration of an organic light emitting diode of at least one of the pixels; calculating a luminance compensation amount of the organic light emitting diode using a linear function of a luminance variation of the organic light emitting diode correspond to the current variation; and generating second data by adjusting bits of first data supplied from an outside using the luminance compensation amount, wherein the current variation of the deterioration of the organic light emitting diode is divided into k sections (k being a natural number which is equal to or greater than 2), and a constant value of the linear function is differently set at each of the k sections.

The linear function may be set as Equation 1:

ΔL=αΔI+β, Equation 1

wherein α and β are constant values of the equation, ΔI is a current variation, and ΔL is a luminance variation in Equation 1.
The luminance compensation amount may be calculated corresponding to the luminance variation ΔL using Equation 2:

ΔT=1/(1−ΔL) Equation 2

wherein ΔT is a luminance compensation amount in Equation 2.

The calculating of the luminance compensation amount may include pre-storing constant values of first pixels of the pixels for each of the k sections, the first pixels being some of the pixels, and calculating constant values of second pixels for each of the k sections, the second pixels being pixels other than the first pixels from among the pixels; and selecting a constant value of a specific section among constant values of the k sections corresponding to the current variation.

The calculating of the constant values for each of the k sections may include extracting constant values of two or more of the first pixels that are adjacent to a specific one of the second pixels for each of the k sections, and calculating a constant value of the specific one of the second pixels for each of the k sections using an interpolation.

The determining of the current variation may include measuring a current flowing in the organic light emitting diode while supplying a reference voltage to the organic light emitting diode, and determining the current variation by comparing a current flowing in the organic light emitting diode with a reference current indicating a current flowing in the organic light emitting diode corresponding to the reference voltage when the organic light emitting diode is not deteriorated.

The second data may be generated by multiplying the first data by the luminance compensation amount. The second data may be generated by applying a gamma value on the luminance compensation amount in an analog mode.

The driving method may further include reducing bits of the first data by a ratio when bits of at least one of the second data exceed a region that can be expressed with grayscale values.

In accordance with yet another embodiment of the present invention, there is provided a driving method of an organic light emitting display device which compensates for deterioration of an organic light emitting diode included in each of pixels using a linear function having different constant values for each of k deterioration sections, k being a natural number that is equal to or greater than 2, including storing constant values of first pixels for each of the k sections, the first pixels being some of the pixels; calculating constant values of second pixels for each of the k sections using an interpolation, the second pixels being pixels other than the first pixels from among the pixels; selecting constant values of a specific one of the k sections in the first pixels and the second pixels corresponding to a deterioration level of the organic light emitting diode included in each of the pixels; and compensating deterioration of the organic light emitting diode using the linear function having the constant value of the specific section.

In accordance with the organic light emitting display device and the driving method thereof according to the exemplary embodiments of the present invention, it is possible to compensate for the deterioration of the organic light emitting diode by dividing a current flowing in the organic light emitting diode and the corresponding luminance variation into a plurality of sections and using the linear function having different constant values for each of the sections.

Further, in the present exemplary embodiments, constant values of some pixels included in a pixel unit (e.g., a display region or display unit) are stored for each of the sections, and constant values of the remaining pixels are calculated using the current flowing in the organic light emitting diode and the constant values of some pixels stored for each of the sections.

As a result, the constant values of some pixels are stored in the storage, and thus it is possible to reduce (e.g., minimize) a size of the storage.

### BRIEF DESCRIPTION OF THE DRAWINGS

Example embodiments will now be described more fully hereinafter with reference to the accompanying drawings; however, they may be embodied in various suitable forms and should not be construed as limited to the embodiments set forth herein. Rather, these embodiments are provided so that this disclosure will be thorough and complete and will fully convey the scope of the example embodiments to those skilled in the art.

In the drawing figures, dimensions may be exaggerated for clarity of illustration. Like reference numerals refer to like elements (or components) throughout.

FIG. 1 illustrates an organic light emitting display device according to an exemplary embodiment of the present invention;

FIG. 2 illustrates one pixel according to an exemplary embodiment of the present invention;

FIG. 3 is a graph illustrating a compensating principle of an organic light emitting display device according to an exemplary embodiment of the present invention;

FIG. 4 is a graph illustrating a method for compensating luminance in a digital driving mode;

FIG. 5 is a graph illustrating a method for compensating luminance in an analog driving mode;

FIG. 6 is a graph illustrating an applying method of a linear function according to an exemplary embodiment of the present invention;

FIG. 7 illustrates a storing method of a constant value according to an exemplary embodiment of the present invention;

FIG. 8 illustrates a process of extracting a constant value of a second pixel from first pixels using an interpolation;

FIG. 9 illustrates an exemplary embodiment of a general interpolation;

FIG. 10 illustrates an exemplary embodiment of the compensator and the timing controller illustrated in FIG. 1; and

FIG. 11 is a flowchart illustrating a deterioration compensating method according to an exemplary embodiment of the present invention.

### DETAILED DESCRIPTION

Hereinafter, embodiments of the present invention and some points that are necessary to easily understand the present invention for a person of an ordinary skill in the art will be described in detail with reference to the accompanying drawings. However, because the present invention can be implemented in various suitable forms within the scope described in the claims, the following descriptions are merely examples regardless of whether it is expressed as such or not. For example, the present invention is not limited by the hereafter disclosed exemplary embodiments, but may be modified in various suitable ways.

It will be understood that, although the terms “first”, “second”, “third”, etc., may be used herein to describe various elements, components, regions, layers, and/or sections, these elements, components, regions, layers and/or sections should not be limited by these terms. These terms are used to distinguish one element, component, region, layer or section from another element, component, region, layer or section. Thus, a first element, component, region, layer, or section discussed below could be termed a second element, component, region, layer, or section, without departing from the spirit and scope of the present invention.

Further, it will also be understood that when one element, component, region, layer and/or section is referred to as being “between” two elements, components, regions, layers, and/or sections, it can be the only element, component, region, layer and/or section between the two elements, components, regions, layers, and/or sections, or one or more intervening elements, components, regions, layers, and/or sections may also be present.

It will be understood that when an element or layer is referred to as being “on,” “connected to,” “coupled to,” “connected with,” “coupled with,” or “adjacent to” another element or layer, it can be “directly on,” “directly connected to,” “directly coupled to,” “directly connected with,” “directly coupled with,” or “directly adjacent to” the other element or layer, or one or more intervening elements or layers may be present. Further “connection,” “connected,” etc. may also refer to “electrical connection,” “electrically connect,” etc. depending on the context in which they are used as those skilled in the art would appreciate. When an element or layer is referred to as being “directly on,” “directly connected to,” “directly coupled to,” “directly connected with,” “directly coupled with,” or “immediately adjacent to” another element or layer, there are no intervening elements or layers present.

The terminology used herein is for the purpose of describing particular embodiments and is not intended to be limiting of the present invention. As used herein, the singular forms “a” and “an” are intended to include the plural forms as well, unless the context clearly indicates otherwise. It will be further understood that the terms “comprise,” “comprises,” “comprising,” “includes,” “including,” and “include,” when used in this specification, specify the presence of stated features, integers, steps, operations, elements, and/or components, but do not preclude the presence or addition of one or more other features, integers, steps, operations, elements, components, and/or groups thereof.

As used herein, the term “and/or” includes any and all combinations of one or more of the associated listed items. Expressions such as “at least one of,” when preceding a list of elements, modify the entire list of elements and do not modify the individual elements of the list. Further, the use of “may” when describing embodiments of the present invention refers to “one or more embodiments of the present invention.” Also, the term “exemplary” is intended to refer to an example or illustration.

As used herein, the term “substantially,” “about,” and similar terms are used as terms of approximation and not as terms of degree, and are intended to account for the inherent deviations in measured or calculated values that would be recognized by those of ordinary skill in the art.

As used herein, the terms “use,” “using,” and “used” may be considered synonymous with the terms “utilize,” “utilizing,” and “utilized,” respectively.

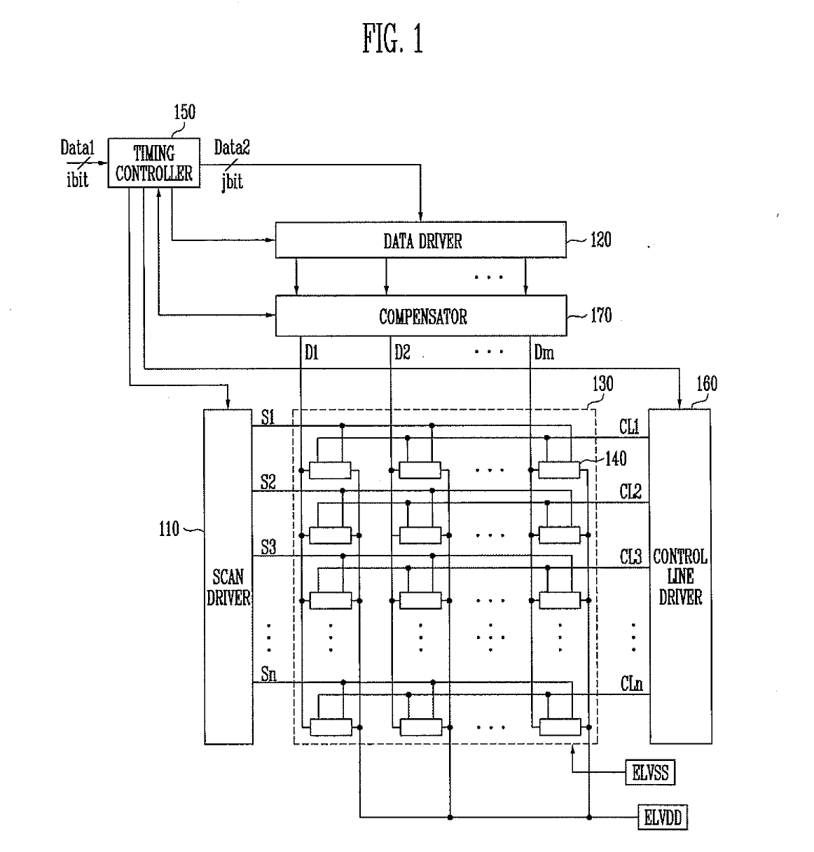

FIG. 1 illustrates an organic light emitting display device according to an exemplary embodiment of the present invention.

Referring to FIG. 1, the organic light emitting display device according to the exemplary embodiment of the present invention includes a pixel unit 130 (i.e., a display unit 130 or a display region 130) including pixels 140 which are disposed at regions that are defined by scan lines S1 to Sn and data lines D1 to Dm, a scan driver 110 for driving the scan lines S1 to Sn, and a control line driver 160 for driving control lines CL1 to CLn.

Further, the organic light emitting display device according to the present exemplary embodiment includes a data driver 120 for supplying data signals to the data lines D1 to Dm, a compensator 170 for extracting current information of the organic light emitting diode from the pixels 140, and a timing controller 150 for controlling the scan driver 110, the data driver 120, the control line driver 160, and the compensator 170. The pixels 140 receive a first power ELVDD and a second power ELVSS from the outside. The pixels 140 control amounts of currents that are supplied from the first power ELVDD to the second power ELVSS via organic light emitting diodes when a data signal corresponding to analog driving is supplied. Further, the pixels 140 control an electrical connection time of the first power ELVDD and the organic light emitting diodes when a data signal corresponding to a digital driving is supplied.

The scan driver 110 supplies a scan signal to the scan lines S1 to Sn according to a timing control signal from the timing controller 150. For example, the scan driver 110 may sequentially supply the scan signal to the scan lines S1 to Sn corresponding to the timing control signal from the timing controller 150. Herein, the scan signal is a voltage that turns on transistors included in the pixels 140.

The control line driver 160 supplies a control signal to the control lines CL1 to CLn according to a timing control signal from the timing controller 150. For example, the control line driver 160 may sequentially supply the control signal to the control lines CL1 to CLn during a sensing period during which the current information of the organic light emitting diode is extracted from the pixels 140. Herein, the control signal is a voltage that turns on transistors included in the pixels 140.

The data driver 120 generates data signals using second data Data2 supplied from the timing controller 150 and supplies the generated data signals to the data lines D1 to Dm. Herein, in an analog driving mode, the data signals may be set to have voltages corresponding to grayscale values (e.g., 256) to be expressed. Further, in a digital driving mode, the data signals may be set to have voltages corresponding to on or off of the driving transistor.

The compensator 170 extracts current information of the organic light emitting diode from each of the pixels 140. For example, the compensator 170 may extract a current value of the organic light emitting diode included in each of the pixels 140 during the sensing period during which the control signals are sequentially supplied to the control lines CL1 to CLn. This will be described later in detail. In addition, the compensator 170 may provide image data from the data driver 120 to the data lines D1 to Dm during a driving period during which an image (e.g., a predetermined image) is displayed in the pixel unit 130.

The timing controller 150 controls the scan driver 110, the data driver 120, the control line driver 160, and the compensator 170. Further, the timing controller 150 converts bit values of first data Data1, corresponding to a luminance-compensated amount supplied from the compensator 170, to generate the second data Data2. Herein, the second data Data2 is set to compensate deterioration of the organic light emitting diodes included in the pixels 140. The first data Data1 may be set to have i bits (i being a natural number), and the second data Data2 may be set to have j bits being a natural number that is equal to or greater than i).

Meanwhile, although the compensator 170 and the timing controller 150 are separately disposed, the present invention is not limited thereto. For example, the compensator 170 may be included in the timing controller 150.

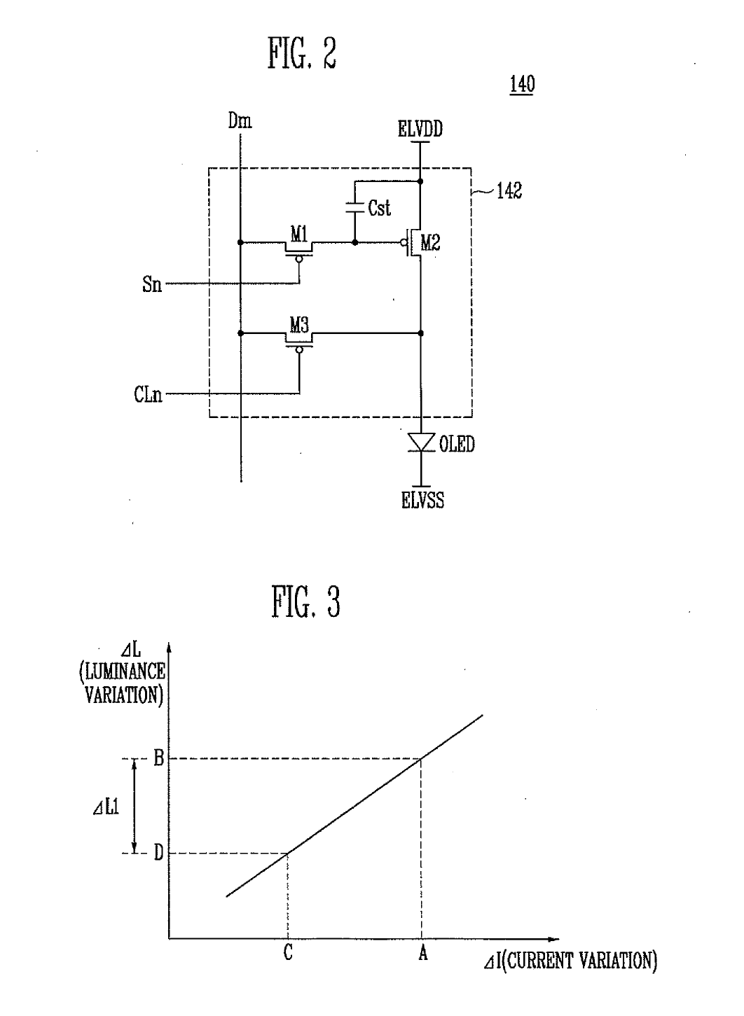

FIG. 2 illustrates one pixel according to an exemplary embodiment of the present invention. For convenience of description, a pixel connected to an n^{th} scan line Sn and an m^{th} data line Dm is illustrated.

Referring to FIG. 2, the pixel 140 according to the exemplary embodiment of the present invention includes an organic light emitting diode (OLED) and a pixel circuit 142 for supplying a current to the organic light emitting diode.

An anode of the organic light emitting diode is connected to the pixel circuit 142, and a cathode thereof is connected to the second power ELVSS. This organic light emitting diode generates light with a set luminance (e.g., a predetermined luminance) corresponding to the current supplied from the pixel circuit 142.

The pixel circuit 142 controls a current amount or a current supply time so as to generate light corresponding to the data signal during the driving period. The pixel circuit 142 supplies current information of the organic light emitting diode to the compensator 170 during the sensing period. To that end, the pixel circuit 142 includes three transistors M1 to M3 and a storage capacitor Cst.

A gate electrode of the first transistor M1 is connected to the scan line Sn, and a first electrode is connected to the data line Dm. A second electrode of the first transistor M1 is connected to a gate electrode of the second transistor M2. As such, this first transistor M1 is turned on when the scan signal is supplied to the scan line Sn. Herein, the first electrode is set to be one of the source electrode and the drain electrode, and the second electrode is set to be the other electrode thereof, which is different from the first electrode.

A gate electrode of the second transistor M2 (i.e., the driving transistor) is connected a second electrode of the first transistor M1, and the first electrode is connected to the first power ELVDD. A second electrode of the second transistor M2 is connected to an anode of the organic light emitting diode. As such, this second transistor M2 is driven according to a voltage applied to the gate electrode thereof, i.e., a voltage stored in the storage capacitor Cst.

A gate electrode of the third transistor M3 is a control line CLn, and a second electrode is connected to an anode of the organic light emitting diode. A first electrode of the third transistor M3 is connected to the data line Dm. As such, this third transistor M3 is turned on when a control signal is supplied to the control line CLn, and is turned off otherwise.

The storage capacitor Cst is connected between the gate electrode of the second transistor M2 and the first power ELVDD. This storage capacitor Cst stores a voltage corresponding to the data signal.

This operation will be described. During the driving period, the first transistor M1 is turned on corresponding to the scan signal supplied to the scan line Sn. When the first transistor M1 is turned on, the data signal from the data line Dm is stored in the storage capacitor Cst.

In analog driving, the second transistor M2 controls an amount of a current flowing to the organic light emitting diode corresponding to the voltage stored in the storage capacitor Cst. In digital driving, the second transistor M2 is turned on or off according to the voltage stored in the storage capacitor Cst. As a result, in digital driving, the grayscale values are implemented according to a turn-on time of the second transistor M2.

During the sensing period, the control signal is sequentially supplied to the control lines CL1 to CLn. When the control signal is supplied to the control line CLn, the third transistor. M3 is turned on. When the third transistor M3 is turned on, a reference voltage from the compensator 170 is supplied to the anode of the organic light emitting diode. A current (e.g., a predetermined current) corresponding to the reference voltage, flows in the organic light emitting diode, and is supplied to the compensator 170 as deterioration information.

For example, an amount of the current flowing in the organic light emitting diode, corresponding to the reference voltage, is changed corresponding to the deterioration. For example, when a resistance of the organic light emitting diode increases, corresponding to the deterioration, the amount of the current, corresponding to the reference voltage, flowing through the organic light emitting diode also changes. As a result, the deterioration information of the organic light emitting diode can be determined using a variation of the current of the organic light emitting diode corresponding to the reference voltage.

Meanwhile, the structure of the pixels 140 according to the present invention is not limited to the aforementioned FIG. 2. Actually, the pixels 140 of the present invention may be modified in various suitable forms to extract current information of the organic light emitting diodes.

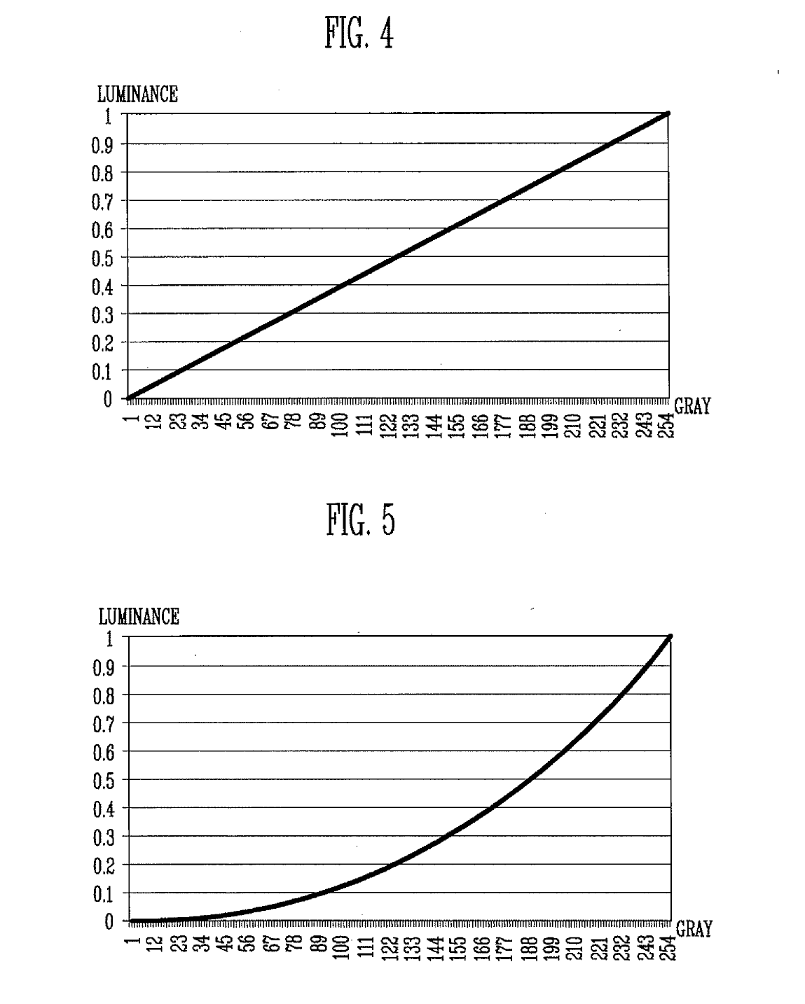

FIG. 3 is a graph illustrating a compensation principle of an organic light emitting display device according to an exemplary embodiment of the present invention. In FIG. 3, the X-axis is a current variation ΔI corresponding to the deterioration of the organic light emitting diode, and Y-axis is a luminance variation ΔL corresponding to the current variation ΔI.

When the organic light emitting diode deteriorates, the current thereof, corresponding to the reference voltage, reduces from a point “A” to a point “C.” The luminance of the organic light emitting diode is reduced from a point “B” to a point “D” corresponding to the deterioration. Accordingly, when the current of the organic light emitting diode, corresponding to the reference voltage, is reduced from the point A to the point C, it is possible to have an image with a desired luminance by increasing the luminance of organic light emitting diode by a first luminance ΔL1: In the present exemplary embodiment, the luminance of the organic light emitting diode is increased, corresponding to the deterioration, by adjusting bits of data Data from the first data Data1 to the second data Data2.

Meanwhile, during the sensing period, the current flowing in the organic light emitting diode, corresponding to the reference voltage, is not a current flowing during an actual driving period. Accordingly, it may be difficult to exactly determine the current reduction corresponding to the deterioration of the organic light emitting diode by merely using the current flowing in the organic light emitting diode corresponding to the reference voltage.

Therefore, in the present exemplary embodiment, an interaction formula of the luminance variation ΔL corresponding to the current variation ΔI of the organic light emitting diode is calculated, and is modeled with a linear function. For example, the graph of FIG. 3 may be modeled with the linear function like Equation 1.

ΔL=αΔI+β Equation

In Equation 1, α and β are constant values of the linear function. ΔI is the current variation, and ΔL is the luminance variation (luminance reduction). When the luminance variation ΔL is calculated in Equation 1, the luminance compensation amount ΔT can be calculated using Equation 2.

ΔT=1/(1−ΔL) Equation 2

For example, when the luminance variation ΔL is set as 10% (0.1) in Equation 1, the luminance compensation amount ΔT is set as 111% (1.11).

FIG. 4 illustrates a method for compensating luminance in a digital driving mode.

Referring to FIG. 4, in digital driving, the luminance is constantly increased corresponding to an increase in the gray (or gray level). Accordingly, the timing controller 150 (or the compensator 170) can generate the second data Data2 by multiplying the first data Data1 outputted from the outside by the luminance compensation amount ΔT (Data2=ΔT×Data1). For the second data Data2, the gray is increased by the luminance compensation amount ΔT, and thus the deterioration of the organic light emitting diode can be compensated.

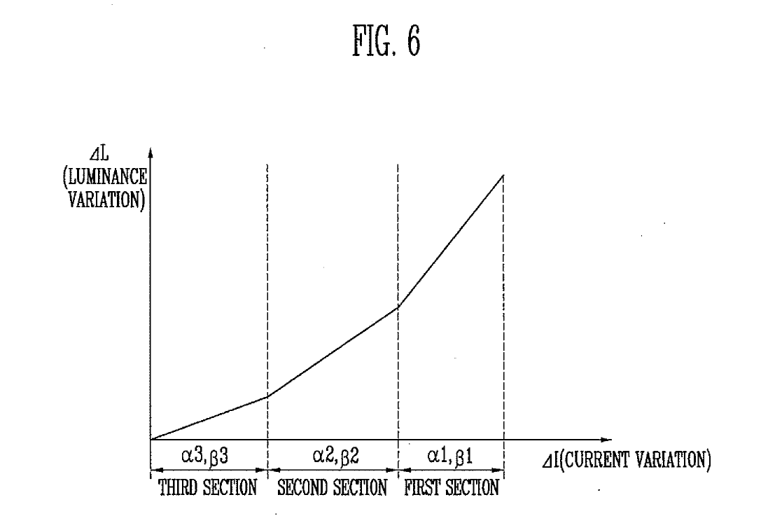

FIG. 5 illustrates a method for compensating luminance in an analog driving mode.

Referring to FIG. 5, in analog driving, the luminance is increased in a curved-line pattern corresponding to the increase in the gray. That is, in analog driving, a gamma value is applied to (e.g., reflected on) the data. Accordingly, the timing controller 150 (or the compensator 170) generates the second data Data2 by multiplying the first data Data1 outputted from the outside by the luminance compensation amount ΔT and considering the gamma value (Data2=ΔT̂(1/gamma)×Data1). For the second data Data2, the gray is increased by luminance compensation amount ΔT obtained by considering the gamma value, and thus the deterioration of the organic light emitting diode can be compensated.

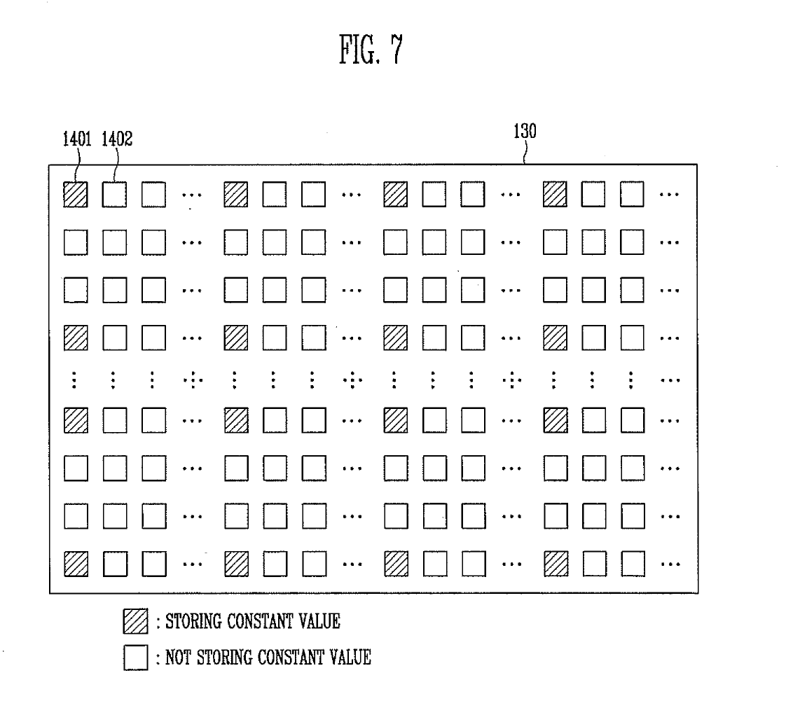

FIG. 6 illustrates a method of applying a linear function according to an exemplary embodiment of the present invention.

Referring to FIG. 6, the deterioration of the organic light emitting diode has been described above as being compensated by modeling the interaction formula of the luminance variation ΔL, corresponding to the current variation ΔI of the organic light emitting diode, with a linear function like Equation 1. It may be difficult to model the luminance variation ΔL, corresponding to the current variation ΔI of the organic light emitting diode, with one linear function. Accordingly, in the exemplary embodiment of the present invention, the current variation ΔI, corresponding to the deterioration of the organic light emitting diode, is divided by a plurality of sections, and is applied with different values α and β.

For example, in the present exemplary embodiment, the deterioration of the organic light emitting diode can be compensated by dividing the current variation ΔI corresponding to the deterioration of the organic light emitting diode into three sections, and using a linear function having the different values α and β at the respective sections.

For example, at a first section, an interaction formula of the luminance variation ΔL, corresponding to the current variation ΔI of the organic light emitting diode, is calculated, and is modeled with a linear function. The constant values are set as α1 and β1.

At a second section, an interaction formula of the luminance variation ΔL, corresponding to the current variation ΔI of the organic light emitting diode, is calculated, and is modeled with a linear function. The constant values are set as α2 and β2.

At a third section, an interaction formula of the luminance variation ΔL, corresponding to the current variation ΔI of the organic light emitting diode, is calculated, and is modeled with a linear function. The constant values are set as α3 and β3.

In this way, as described above, the reliability of the deterioration compensation can be accomplished by dividing a deterioration level of the organic light emitting diode into a plurality of sections and by applying different constant values α and β for each of the sections.

Meanwhile, the constant values α1, α2, α3, β1, β2, and β3 may be differently set at each of the pixels 140 corresponding to material characteristics and deposition conditions of the organic light emitting diodes. The constant values α1, α2, α3, β1, β2, and β3, corresponding to each characteristic of the pixels 140, are pre-stored before the panels are shipped.

Then, the constant values (one of the values α1, α2 and α3 and one of the values β1, β2 and β3), corresponding to the deterioration section and which are pre-stored, are extracted and correspond to the current variation ΔI of the organic light emitting diode included in each of the pixels 140, and the luminance variation ΔL, corresponding to the extracted constant values, is calculated using Equation 1.

After the luminance variation ΔL is calculated, the luminance compensation amount ΔT, corresponding to the luminance variation ΔL, is calculated using Equation 2. Then, by changing the first data Data1 into the second data Data2, corresponding to the luminance compensation amount ΔT, it is possible to compensate for the deterioration of the organic light emitting diode included in each of the pixels 140.

Meanwhile, as described above, when different constant values α1, α2, α3, β1, β2, and β3 are stored for each of the pixels 140, a capacity of the memory is increased, thereby increasing a size thereof. Particularly, as the section corresponding to the organic light emitting diode is increased, the size of the memory is sharply increased.

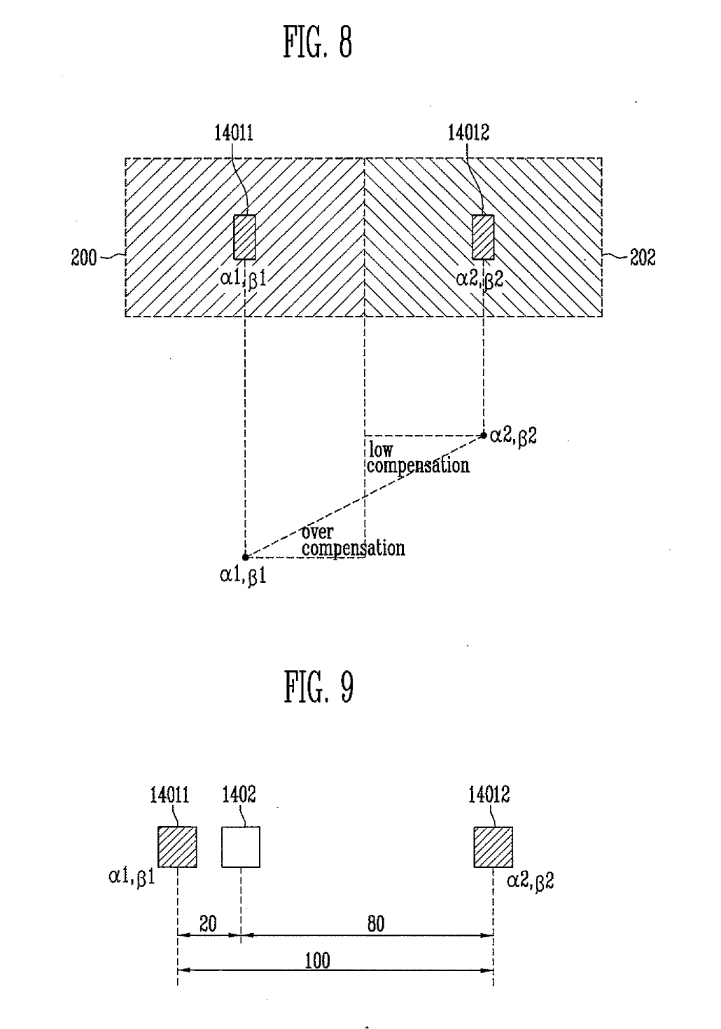

FIG. 7 illustrates a method of storing a constant value according to an exemplary embodiment of the present invention.

Referring to FIG. 7, in the present exemplary embodiment, constant values α1, α2, α3, β1, β2, and β3 of some pixels 140 included in the pixel unit 130 are pre-stored in a memory.

Next, for convenience of description, pixels of which constant values α1, α2, α3, β1, β2, and β3 are stored in the memory are referred to as first pixels 1401, and pixels of which constant values α1, α2, α3, β1, β2, and β3 are not stored in the memory are referred to as second pixels 1402.

The first pixels 1401 are disposed in a set pattern (e.g., a predetermined pattern) in the pixel unit 130. The second pixels 1402 are disposed to be adjacent to the first pixels 1401. Herein, there may be more of the second pixels 1402 than there are of the first pixels 1401 in the pixel unit 130, in order to reduce (e.g., minimize) the memory capacity.

The constant values α1, α2, α3, β1, β2, and β3 of the second pixels 1402 are calculated from two or more first pixels 1401 that are adjacently positioned, using interpolation. Because the constant values α1, α2, α3, β1, β2, and β3 of the first pixels 1401 are stored in the memory, the memory capacity can be reduced (e.g. minimized).

Meanwhile, it may be difficult to exactly extract the constant values when the constant values α1, α2, α3, β1, β2, and β3 of the second pixel 1402 are calculated from the adjacent first pixels 1401 using interpolation. For example, in a mobile product in which icons and/or the like are displayed as fixed patterns, even the adjacent pixels may have different deterioration levels, and thus it may be difficult to extract reliable constant values α1, α2, α3, β1, β2, and β3 by simply applying the interpolation.

FIG. 8 illustrates a process of extracting a constant value of a second pixel from first pixels using an interpolation.

Referring to FIG. 8, second pixels 1402 positioned at a first block 200 based on a first first pixel 14011, corresponding to an image that is displayed on the pixel unit 130, has a deterioration characteristic corresponding to a first section, and second pixels 1402 positioned at a second block 202 based on a second first pixel 14012 has a deterioration characteristic corresponding to a second section.

For second pixels positioned between the first first pixel 14011 and the second first pixel 14012, a constant value is extracted corresponding to the interpolation. Herein, for the interpolation, various suitable currently well-known methods may be applied.

For example, as shown in FIG. 9, a constant value may be extracted corresponding to the second pixel 1402 positioned between the first first pixel 14011 and second first pixel 14012. In other words, the constant value of the second pixel 1402 can be extracted by multiplying constant values α1 and β1 of the first first pixel 14011 by a weight value 20/100 and by multiplying constant values α2 and β2 of the second first pixel 14012 by a weight value 80/100.

However, when the constant values of the second pixels are extracted using the aforementioned interpolation, over-compensation is performed on the deterioration for the second pixels positioned at the first block 200 and between the first first pixel 14011 and the second first pixel 14012. Further, when the constant values of the second pixels are extracted using the aforementioned interpolation, low compensation is performed on the deterioration for the second pixels positioned at the second block 202 and between the first first pixel 14011 and the second first pixel 14012.

Accordingly, a method for extracting reliable constant values of the second pixels 1402 while storing the constant values α1, α2, α3, β1, β2, and β3 of the first pixels 1401 are necessary.

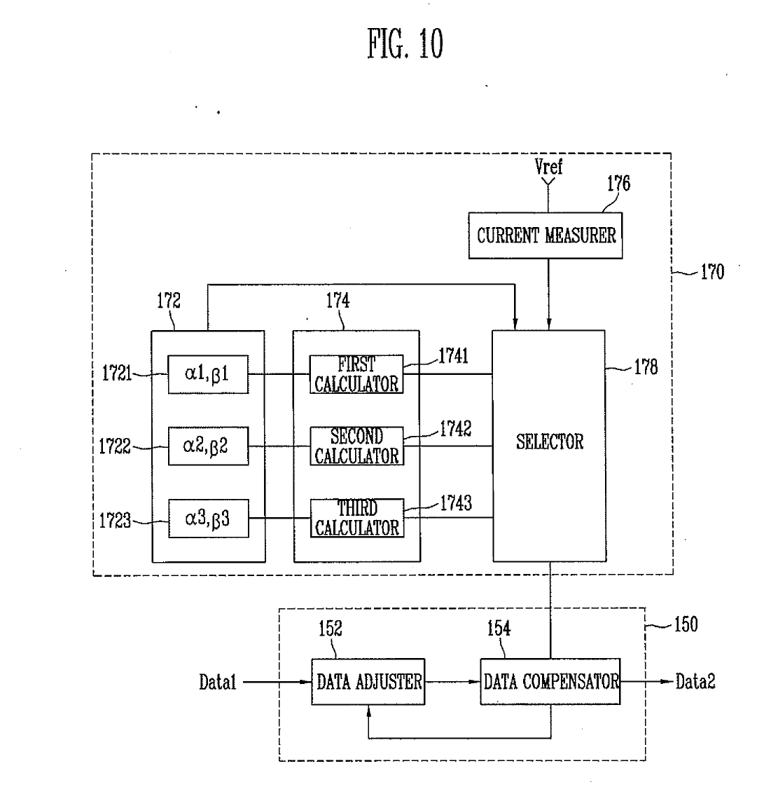

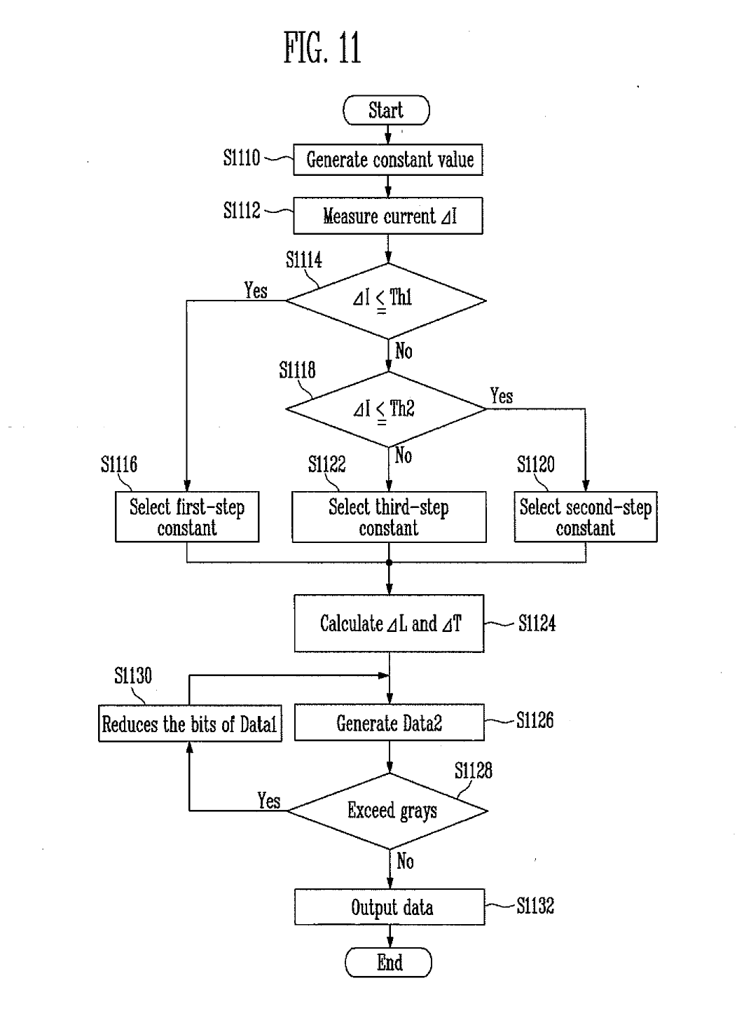

FIG. 10 illustrates an exemplary embodiment of the compensator and the timing controller illustrated in FIG. 1.

Referring to FIG. 10, the compensator 170 according to the present exemplary embodiment includes a storage 172, a calculator 174, a current measurer 176, and a selector 178.

The storage 172 stores the constant values α1, α2, α3, β1, β2, and β3 for each first pixel 1401. To that end, the storage 172 includes a first storage 1721, a second storage 1722, and a third storage 1723.

The first storage 1721 stores first constant values α1 and β1 corresponding to each first section of the first pixels 1401. The second storage 1722 stores second constant values α2 and β2 corresponding to each second section of the first pixels 1401. The third storage 1723 stores third constant values α3 and β3 corresponding to each third section of the first pixels 1401.

The calculator 174 calculates constant values α1, α2, α3, β1, β2, and β3 of the second pixel 1402 using constant values α1, α2, α3, β1, β2, and β3 of the first pixels 1401 that are adjacent thereto. To that end, the calculator 174 includes a first calculator 1741, a second calculator 1742, and a third calculator 1743.

The first calculator 1741 calculates first constant values α1 and β1 of the second pixels 1402 corresponding to first constant values α1 and β1 stored in a first storage 1721. For example, the first calculator 1741 may calculate first constant values α1 and β1 of a specific second pixel 1402 by extracting first constant values α1 and β1 of two or more first pixels 1401 that are adjacent to the specific second pixel 1402 from the first storage 1721 and using interpolation from the extracted first constant values α1 and β1. Herein, each of the first constant values α1 and β1 of the first pixels 1401 that are adjacent to the specific second pixel 1402 is identically or differently set corresponding to the material characteristics and deposition conditions.

The second calculator 1742 calculates second constant values α2 and β2 of the second pixels 1402 corresponding to second constant values α2 and β2 stored in a second storage 1722. For example, the second calculator 1742 may calculate second constant values α2 and β2 of the specific second pixel 1402 by extracting second constant values α2 and β2 of the two or more first pixels 1401 that are adjacent to the specific second pixel 1402 from the second storage 1722 and using interpolation from the extracted second constant values α2 and β2. Herein, each of the second constant values α2 and β2 of the first pixels 1401 that are adjacent to the specific second pixel 1402 is identically or differently set corresponding to the material characteristics and deposition conditions.

The third calculator 1743 calculates third constant values α3 and β3 of the second pixels 1402 corresponding to the third constant values α3 and β3 stored in a third storage 1723. For example, the third calculator 1743 may calculate third constant values α3 and β3 of the specific second pixel 1402 by extracting third constant values α3 and β3 of the two or more first pixels 1401 that are adjacent to the specific second pixel 1402 from the third storage 1723 and using interpolation from the extracted third constant values α3 and β3. Herein, each of the third constant values β3 and β3 of the first pixels 1401 that are adjacent to the specific second pixel 1402 is identically or differently set corresponding to the material characteristics and deposition conditions.

The current measurer 176 extracts current information of the organic light emitting diodes from the pixels 140. To that end, the current measurer 176 supplies a reference voltage Vref to the pixels 140 during the sensing period and measures a current I flowing in the organic light emitting diode in each of the pixels 140 corresponding to the reference voltage Vref. The current measurer 174 compares the current I flowing in the organic light emitting diode with a reference current and calculates the current variation ΔI corresponding to a comparative result. Herein, when the organic light emitting diode is not deteriorated, the reference current may be set as a current flowing in the organic light emitting diode corresponding to the reference voltage Vref. In addition, the current variation ΔI of each of the pixels 140 measured in the current measurer 176 may be converted into a digital value to be supplied to the selector 178.

The selector 178 receives the current variation ΔI of each of the pixels 140 from the current measurer 176. For example, the current variation ΔI of the specific second pixel 1402 may be supplied to the selector 178. Then, the selector 178 selects one of the first constant values α1 and β1, the second constant values α2 and β2, and the third constant values α3 and β3 of the specific second pixel 1402 supplied from the calculator 174 corresponding to the current variation ΔI of the specific second pixel 1402, that is, corresponding to a deteriorated section.

For example, when a deterioration level, corresponding to the current variation ΔI of the specific second pixel 1402, is within a first section, the selector 178 selects the first constant values α1 and β1 from the first calculator 1741, and supplies the first constant values α1 and β1 and the current variation ΔI of the specific second pixel 1402 to the data compensator 154.

When the deterioration level, corresponding to the current variation ΔI of the specific second pixel 1402, is within a second section, the selector 178 selects the second constant values α2 and β2 supplied from the second calculator 1742, and supplies the second constant values α2 and β2 of the current variation ΔI of the specific second pixel 1402 to the data compensator 154.

When the deterioration level, corresponding to the current variation ΔI of the specific second pixel 1402, is within a third section, the selector 178 selects the third constant value α3 and β3 supplied from the third calculator 1743, and supplies the third constant value α3 and β3 and the current variation ΔI of the specific second pixel 1402 to the data compensator 154.

Additionally, the selector 178 may select a constant value (one of the values α1, α2 and α3 and one of the Values β1, β2 and β3) of each of the pixels 140 corresponding to the current variation ΔI of the first pixels 1401 and a constant value (one of the values α1, α2 and +3 and one of the values β1, β2 and β3) corresponding to the current variation ΔI to the data compensator 154. To that end, the selector 178 may be connected to the storage 172 via the calculator 174, or may be directly connected to the storage 172.

The timing controller 150 includes a data adjuster 152 and a data compensator 154.

The data compensator 154 receives the current variation ΔI and the constant values (one of the values α1, α2 and α3 and one of the values β1, β2 and β3) of each of the pixels 140 from the selector 178. The data compensator 154, which receives the current variation ΔI and the constant values (one of the values α1, α2 and α3 and one of the values β1, β2 and β3) of each of the pixels 140, calculates the luminance variation ΔL of each of the pixels 140 using the Equation 1. The data compensator 154 calculates the luminance compensation amount ΔT using Equation 2.

Then, the data compensator 154 generates the second data Data2 by adjusting bits of the first data Data1 corresponding to the luminance compensation amount ΔT. Herein, the second data Data2 is set to compensate deterioration information of the organic light emitting diode included in each of the pixels 140 corresponding to the luminance compensation amount ΔT.

Meanwhile, the second data Data2 is generated by increasing bits of the first data Data1. Accordingly, the bits of the second data Data2 corresponding to the deterioration of the organic light emitting diode may exceed a region that can be expressed with grayscale values. When bits of at least one second data Data2 exceeds the region that can be expressed with grayscale values, the data adjuster 152 reduces the bits of the first data Data1 at a set ratio (e.g., a predetermined ratio).

When the bits of the first data Data1 are reduced at the set ratio (e.g., the predetermined ratio) (e.g., 10%), the luminance of the pixel unit 130 is uniformly decreased, and thus it is possible to maintain uniform luminance. Further, the bits of the first data Data1 are reduced, the second data Data2 is positioned at the region that can be expressed with grayscale values. Accordingly, it is possible to stably compensate for the deterioration of the organic light emitting diode.

As described above, in the present exemplary embodiment, the constant values α1, α2, α3, β1, β2, and β3 of the second pixels 1402 are calculated in real time using the constant values α1, α2, α3, β1, β2, and β3 of the first pixels 1401 which are pre-stored, and the constant values (one of the values α1, α2 and α3 and one of the values β1, β2 and β3) to be applied to the calculation can be extracted from among the constant values α1, α2, α3, β1, β2, and β3 calculated corresponding to the current variation ΔI.

As a result, in the present exemplary embodiment, the constant values (one of the values α1, α2 and α3 and one of the values β1, β2 and β3) of the second pixels 1402, calculated by the calculator 174 corresponding to the current variation ΔI, can be extracted, thereby accomplishing the reliability of the deterioration compensation.

Although three sections have been described to be included corresponding to the deterioration of the organic light emitting diode, the present invention is not limited thereto. For example, k (k being a natural number that is equal to or greater than 2) may be included corresponding to the deterioration of the organic light emitting diode.

FIG. 11 is a flowchart illustrating a method of compensating for deterioration according to an exemplary embodiment of the present invention.

### Generation of Constant Value: S1110

The calculator 174 calculates the constant values α1, α2, α3, β1, β2, and β3 of the second pixels 1402 using the constant values α1, α2, α3, β1, β2, and β3 of the first pixels 1401 stored in the storage 172. For example, the calculator 174 may calculate the constant values α1, α2, α3, β1, β2, and β3 of the specific second pixel 1402 for each section using the constant values α1, α2, α3, β1, β2, and β3 of two or more first pixels 1401 adjacent to the specific second pixel 1402. Herein, the calculator 174 may calculate the constant values α1, α2, α3, β1, β2, and β3 of the specific second pixel 1402 for each section using interpolation.

### Measurement of Current Variation ΔI: S1112

For the sensing period, the current measurer 176 supplies the reference voltage Vref to the organic light emitting diode included in each of the pixels 140. When the reference voltage Vref is supplied to the organic light emitting diode, a current I flows in the reference voltage Vref corresponding to the organic light emitting diode. Next, the current measurer 174 determines the current variation ΔI by comparing the current I of the organic light emitting diode with the reference current value. In step S1112, the current variation ΔI of each of the pixels 140 may be stored as a digital value.

### Extraction of Constant Value Corresponding to Current Variation ΔI: S1114 to S1122

The current variation ΔI measured in the current measurer 176 is supplied to the selector 178. The selector 178 determines a deterioration section of the specific second pixel 1402 corresponding to the current variation ΔI, and selects the constant values (one of the values α1, α2 and α3 and one of the values β1, β2 and β3) corresponding to the determined deterioration section.

For example, the selector 178 may compare a first threshold value Th1 corresponding to each section with the current variation ΔI, compare a second threshold value Th2 corresponding to each section with the current variation ΔI, and select the constant values (one of the values α1, α2 and α3 and one of the values β1, β2 and β3) corresponding to the result of the comparison.

In other words, the selector 178 selects the first constant values α1 and β1 from the first calculator 1741 when it is determined that the current variation ΔI is equal to or smaller than the first threshold value Th1 (S1114, S1116).

The selector 178 selects the second constant values α2 and β2 from the second calculator 1742 when it is determined that the current variation ΔI is greater than the first threshold value Th1 (S1114) and equal to or smaller than the second threshold value Th2 (S1118, S1120).

Further, the selector 178 selects the third constant values α3 and β3 from the third calculator 1743 when it is determined that the current variation ΔI exceeds both the first threshold value Th1 (S1114) and the second threshold value Th2 (S1118, S1122).

### Calculation of Luminance Variation ΔL and Luminance Compensation Amount ΔT: S1124

After the constant values (one of the values α1, α2 and α3 and one of the values β1, β2 and β3) and the current variation ΔI of the specific second pixel 1402 are selected by the selector 178, the data compensator 154 calculates the luminance variation ΔL and the corresponding luminance compensation amount ΔT using Equations 1 and 2.

### Generation and Output of Second Data Data2: S1126 to S1132

After the luminance compensation amount ΔT is calculated in step S1124, the data compensator 154 adjusts bits of the first data Data1 using the luminance compensation amount ΔT to generate the second data Data2 (S1126). The second data Data2 generated in the data compensator 154 is transferred to the data driver 120, and the data driver 120 generates data signals using the second data Data2 (S1132). Then, the data signals are supplied to the specific second pixel 1402 to compensate for the deterioration of the organic light emitting diode.

In addition, when the bits of the second data Data2 exceed the region that can be expressed with grayscale values, the data adjuster 152 reduces the bits of the first data Data1 at a set ratio (e.g., a predetermined ratio) (S1128, S1130). Then, it is set in a range that can represent grayscale values of the second data Data2 generated by the first data Data1, and thus it is possible to stably compensate for the deterioration of the organic light emitting diode.

In addition, for convenience of description, the transistors are shown as p-channel MOSETs (PMOS), but the present invention is not limited thereto. In other words, the transistors may be formed of n-channel MOSETs (NMOS).

Further, in the present invention, the organic light emitting diode generates red, green, or blue light in response to currents supplied from the driving transistor, but the present invention is not limited thereto. For example, the organic light emitting diode may generate white light in response to a current supplied from the driving transistor. Color images may be implemented using an additional color filter, or the like.

Example embodiments have been disclosed herein and although specific terms are employed, they are used and are to be interpreted in a generic and descriptive sense only and not for purpose of limitation. In some instances, as would be apparent to one of ordinary skill in the art as of the filing of the present application, features, characteristics and/or elements (or components) described in connection with a particular embodiment may be used singly or in combination with features, characteristics and/or elements (or components) described in connection with other embodiments unless otherwise indicated. Accordingly, it will be understood by those of skill in the art that various suitable changes in form and details may be made without departing from the spirit and scope of embodiments of the present invention as set forth in the following claims and their equivalents.

What is claimed is:

1. An organic light emitting display device comprising:
a compensator configured to extract current information of organic light emitting diodes in pixels; and
a timing controller configured to determine a luminance compensation amount corresponding to the current information and to generate second data by adjusting bits of first data supplied from an outside, the first data being adjusted corresponding to the luminance compensation amount,
wherein the compensator is further configured to divide a current variation corresponding to deterioration of the organic light emitting diodes into k sections and to calculate the luminance compensation amount using a linear function of a luminance variation corresponding to the current variation at each of the k sections.

2. The organic light emitting display device of claim 1, wherein the linear function is set as Equation 1:
ΔL=αΔI+β Equation 1
wherein α and β are constant values of the equation, ΔI is a current variation, and ΔL is a luminance variation in Equation 1.

3. The organic light emitting display device of claim 2,
wherein the constant values α and β of the linear function are set differently at each of the k sections.

4. The organic light emitting display device of claim 3,
wherein the constant values of the linear function are identically or differently set for each of the pixels in each of the k sections.

5. The organic light emitting display device of claim 3, wherein the compensator comprises:
a storage configured to store constant values of first pixels for each of the k sections, the first pixels being some of the pixels,
a calculator configured to calculate constant values of second pixels for each of the k sections, the second pixels being pixels other than the first pixels from among the pixels,
a current measurer configured to determine the current variation, and
a selector configured to select constant values of the first pixels and the second pixels for each of the k sections corresponding to the current variation.

6. The organic light emitting display device of claim 5, wherein the calculator is configured to:
extract constant values of two or more of the first pixels that are adjacent to a specific one of the second pixels for each of the k sections, and
calculate a constant value of the specific one of the second pixels for each of the k sections using an interpolation.

7. The organic light emitting display device of claim 5, wherein the current measurer is configured to:
supply a reference voltage to the organic light emitting diode of each of the pixels, and
determine the current variation by comparing a current flowing in the organic light emitting diode with a reference current indicating a current flowing in the organic light emitting diode corresponding to the reference voltage when the organic light emitting diode is not deteriorated.

8. The organic light emitting display device of claim 2, wherein the timing controller comprises:
a data compensator configured to calculate the luminance compensation amount using Equation 2, and to generate the second data by multiplying the first data by the luminance compensation amount:
ΔT=1/(1−ΔL), Equation 2
wherein ΔT is a luminance compensation amount in Equation 2.

9. The organic light emitting display device of claim 8, wherein the timing controller further comprises:
a data adjuster configured to reduce bits of the first data by a ratio when bits of at least one of the second data exceed a region that can be expressed with grayscale values.

10. The organic light emitting display device of claim 8,
wherein the data compensator is configured to generate the second data by applying a gamma value on the luminance compensation amount in an analog mode.

11. A method of driving an organic light emitting display device comprising pixels, the method comprising:
determining a current variation corresponding to deterioration of an organic light emitting diode of at least one of the pixels;
calculating a luminance compensation amount of the organic light emitting diode using a linear function of a luminance variation of the organic light emitting diode correspond to the current variation; and
generating second data by adjusting bits of first data supplied from an outside using the luminance compensation amount,
wherein the current variation of the deterioration of the organic light emitting diode is divided into k sections (k being a natural number which is equal to or greater than 2), and a constant value of the linear function is differently set at each of the k sections.

12. The method of claim 11, wherein the linear function is set as Equation 1:
ΔL=αΔI+β Equation 1
wherein α and β are constant values of the equation, ΔI is a current variation, and ΔL is a luminance variation in Equation 1.

13. The method of claim 12, wherein the luminance compensation amount is calculated corresponding to the luminance variation ΔL using Equation 2:
ΔT=1/(1−ΔL) Equation 2
wherein ΔT is a luminance compensation amount in Equation 2.

14. The method of claim 11, wherein the calculating of the luminance compensation amount comprises:
pre-storing constant values of first pixels of the pixels for each of the k sections, the first pixels being some of the pixels,
calculating constant values of second pixels for each of the k sections, the second pixels being pixels other than the first pixels from among the pixels; and
selecting a constant value of a specific section among constant values of the k sections corresponding to the current variation.

15. The method of claim 14, wherein the calculating of the constant values for each of the k sections comprises:
extracting constant values of two or more of the first pixels that are adjacent to a specific one of the second pixels for each of the k sections, and
calculating a constant value of the specific one of the second pixels for each of the k sections using an interpolation.

16. The method of claim 11, wherein the determining of the current variation comprises:
measuring a current flowing in the organic light emitting diode while supplying a reference voltage to the organic light emitting diode, and
determining the current variation by comparing a current flowing in the organic light emitting diode with a reference current indicating a current flowing in the organic light emitting diode corresponding to the reference voltage when the organic light emitting diode is not deteriorated.

17. The method of claim 11,
wherein the second data is generated by multiplying the first data by the luminance compensation amount.

18. The method of claim 17,
wherein the second data is generated by applying a gamma value on the luminance compensation amount in an analog mode.

19. The method of claim 11, further comprising
reducing bits of the first data by a ratio when bits of at least one of the second data exceed a region that can be expressed with grayscale values.

20. A method of driving an organic light emitting display device which compensates for deterioration of an organic light emitting diode in each of pixels using a linear function having different constant values for each of k deterioration sections, k being a natural number that is equal to or greater than 2, the method comprising:
storing constant values of first pixels for each of the k sections, the first pixels being some of the pixels;
calculating constant values of second pixels for each of the k sections using an interpolation, the second pixels being pixels other than the first pixels from among the pixels;
selecting constant values of a specific one of the k sections in the first pixels and the second pixels corresponding to a deterioration level of the organic light emitting diode in each of the pixels; and
compensating deterioration of the organic light emitting diode using the linear function having the constant value of the specific section.
